(19) United States
(12) Patent Application Publication
(10) Pub. No.: US 2009/0089075 A1
(43) Pub. Date: Apr. 2, 2009

(54) FUEL ENVIRONMENTAL EVALUATION SYSTEM

(76) Inventors: MASAFUMI NOUJIMA, TOKAI (JP); AKIYOSHI KOMURA, HITACHI (JP); TAKAO ISHIKAWA, HITACHI (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/194,038

(22) Filed: Aug. 19, 2008

(30) Foreign Application Priority Data
Sep. 28, 2007 (JP) 2007-252961

(51) Int. Cl. G06Q 99/00

(52) U.S. Cl. 705/1

(57) ABSTRACT

The invention provides a fuel environmental evaluation system for evaluating a fuel environment characteristic in an energy distribution process comprising a means for inputting an amount of raw material supplied to equipment for each process of energy distribution, an amount of product produced from each equipment for each process, and a type and an amount of utility supplied to the equipment for each process when producing the product; a storage means for storing input data; a storage means for storing a basic unit for an amount of environmentally affecting matter emission per unit amount of an environmental emission matter in the raw material, utility and product; an environmental emission calculation section for calculating an amount of environmentally affecting matter emission from data of amounts of the raw material, utility and product, and the basic unit for the amount of environmentally affecting matter emission; and a means for storing a calculation result from the environmental emission calculation section.

### CLAIM OF PRIORITY

The present application claims priority from Japanese Patent Application JP 2007-252961 filed on Sep. 28, 2007, the content of which is hereby incorporated by reference into this application.

### FIELD OF THE INVENTION

The present invention relates to a fuel environmental evaluation system and an environmentally affecting matter emission evaluation system that manages emission of environmentally affecting matters such as carbon dioxide.

### BACKGROUND OF THE INVENTION

Presently, the environmental degradation due to greenhouse effect gases such as carbon dioxide (CO₂) becomes an important social problem. In recent years, the greenhouse gases are pointed out as a cause of the temperature rise on a global scale, which is one of the serious international issues. Under such circumstances, Kyoto Protocol on preventing global warming took effect in February, 2005, to fully implement the international agreements concerning numeric targets for reducing greenhouse effect gases, emissions trading, joint implementation, and clean development mechanism.

A trend has been emerging to institutionalize the emissions trading, namely, trading the emission reduction of CO₂ as an emission credit and forming a market for the amount of CO₂ to be emitted or suppressed. The emissions trading in business needs adequate management of the CO₂ emission in various production activities, requiring a means for grasping CO₂ emissions within a certain range.

In many cases, CO₂ is emitted by activities such as energy conversion of fossil fuels and materials or production. For example, the thermal power technology, which uses a turbine to convert coal or petroleum energies into electricity, combusts the fossil fuel in the turbine to generate CO₂. CO₂ is emitted by burning the fossil fuel and the emission amount is proportional to a type or amount of the burnt fossil fuel.

It is possible to estimate CO₂ emissions based on production or energy conversion activities by referencing a fuel record on fuel conversion processes. To perform this estimation, Japanese Patent Application Laid-Open Publication No. 2002-181304 discloses a method for measuring an electric generating capacity and a fuel amount and calculating CO₂ emissions. Other techniques are disclosed in Japanese Patent Application Laid-Open Publication No. 2001-184406 and No. 22002-112458 for calculating and managing CO₂ emissions resulting from electric energy generation by a plurality of power generation plants to manage CO₂ emissions with respect to mixed electric powers supplied from the power generation plants to customers. According to Japanese Patent Application Laid-Open Publication No. 2005-157716, another technique is disclosed for calculating and managing CO₂ emissions from widely distributed CO₂ emission sources, including generally distributed fuels, such as gasoline and light gas oil used for vehicles and kerosene for heating, in addition to electricity generation.

These conventional techniques manage CO₂ emissions in accordance with CO₂ emitting locations, such as power generation plants and vehicles. In a case of refining crude petroleum to produce gasoline, transporting the gasoline to local gas stations, supplying the gasoline to cars that consume the gasoline, gasoline refiners, tankers, and cars emit CO₂. In this case, if a carbon tax, which is proposed to suppress CO₂ emissions, is imposed on the gasoline as a final product supplied at the gas station, the carbon tax payment at each company or place may be hardly identifiable when facilities that refine, transport, or sell the gasoline are different companies or located in different places.

In a strict sense, consideration of environmental characteristics of energy needs to include issues of not only CO₂ emission places but also accumulated energy and CO₂ consumed during processes of mining the primary energy and transporting, storing, producing, and supplying fuels. If evaluating environmental characteristics of hydrogen, for example, there is a great difference in the environmental characteristics between electrolytically generated hydrogen from water through conversion of a natural energy into electricity and hydrogen generated by reforming petroleum.

The present invention has been made in consideration of the foregoing. An object of the present invention is to provide an end consumer with a method of measuring CO₂ emissions and for managing data for processes by quantifying an environmental emission or a turn volume of CO₂ based on performance and fuel characteristics of a system and equipment related to each process for selling primary reserved fuel in accordance with environmental characteristics of consumers, for example, based on the amount of raw material and the amount of energies such as electricity and gas used for fuel production. Another object of the present invention is to provide a method for measuring CO₂ emissions and for managing data for each process with higher accuracy in consideration of CO₂ emissions amount during processes for generating energies, such as electricity and gas, used for processing raw fuel materials.

### SUMMARY OF THE INVENTION

To achieve the objects, the invention provides a fuel environmental evaluation system for evaluating a fuel environment characteristic in an energy distribution process, comprising a database for storing an amount of raw material supplied to equipment for each process of energy distribution, an amount of product produced from the equipment for each process, and a type and an amount of utility supplied to the equipment for each process when producing the product, and an environmental emission basic unit for the product; an environmentally affecting matter emission evaluation means for evaluating an amount of an environmentally affecting matter emitted when producing the product, based on data stored in the database; and a product-related environmentally affecting matter emission amount storage means for storing a result evaluated by the environmentally affecting matter emission evaluation means. The system evaluates an amount of accumulated environmentally affecting matter emission in all processes of energy distribution distributing energy processed from a well head material. The fuel environmental evaluation system may include a means for measuring amount of supplied utilities, such as electricity, gas, and other fuels, and energy in each process; a data storage apparatus for storing the measurement results and an environmental emission basic unit of the fuel; an environmentally affecting matter emission evaluation means by using the data to evaluate amount of environmentally affecting matter generated from the utility in the process; and a means for storing the result.

The invention enables the environmentally affecting matter emission evaluation including environmentally affecting matter emission quantities generated while the energy itself is distributed and utilities, resulting in detailed evaluation of the amount of the environmentally affecting matter emission. Especially, the invention can provide an effective system that evaluates environmental characteristics of natural energy or energy generated from side products.

An operator for each process can regard the environmental characteristics as an indicator for purchasing a raw material.

### BRIEF DESCRIPTION OF THE DRAWINGS

FIG. 1 is a schematic diagram showing an embodiment of the invention in energy distribution processes;

FIG. 2 is a system configuration diagram of an environmentally affecting matter emission evaluation system;

FIG. 3 shows a system configuration of an energy production means;

FIG. 4 shows an example of data stored in an environmentally affecting matter emission storage means;

FIG. 5 is a flow chart for calculating amount of an environmentally affecting matter emission during an energy production process;

FIG. 6 shows an example of data stored in a calculation result storage section;

FIG. 7 shows a schematic view of an energy transportation means;

FIG. 8 is a schematic diagram showing a system configuration of the energy transportation means;

FIG. 9 is a schematic diagram showing a system configuration of the energy storage means;

FIG. 10 shows another embodiment of the environmentally affecting matter emission evaluation system;

FIG. 11 shows an example of energy data management;

FIG. 12 shows an example of another energy data management; and

FIG. 13 shows an example of data stored in utility introduction information.

### DETAILED DESCRIPTION OF THE PREFERRED EMBODIMENTS

A fuel environmental evaluation system according to the invention includes following means and apparatus and executes a fuel treatment process such as mining, converting, transforming, and using, a transportation process, and a storage process. One of the means measures a raw material of a fuel, an amount of the fuel, and the energy amount of the fuel. Another means measures a fuel amount to be obtained or an energy amount from the fuel. The system also includes a data storage apparatus which stores data, such as a measurement result and an environmental emission basic unit of the fuel. Another means is an environmentally affecting matter emission evaluation means which evaluates an amount of environmentally affecting matter generated from the process the data. Another means is a storage means which stores a result evaluated by the environmentally affecting matter emission evaluation means. The each process includes a means which measures the amount of supplied utilities such as electricity, gas, and other fuels and also measures the energy amount; a data storage apparatus which stores the measurement results and an environmental emission basic unit of the fuel; an environmentally affecting matter emission evaluation means which uses the data to evaluate the amount of environmentally affecting matter generated from the utility for the process; and a storage means which stores the evaluation results. The environmentally affecting matter emission evaluation means is also termed an environmentally affecting matter emission evaluation system

Embodiments of the present invention will be described in further detail with reference to drawings.

### First Embodiment

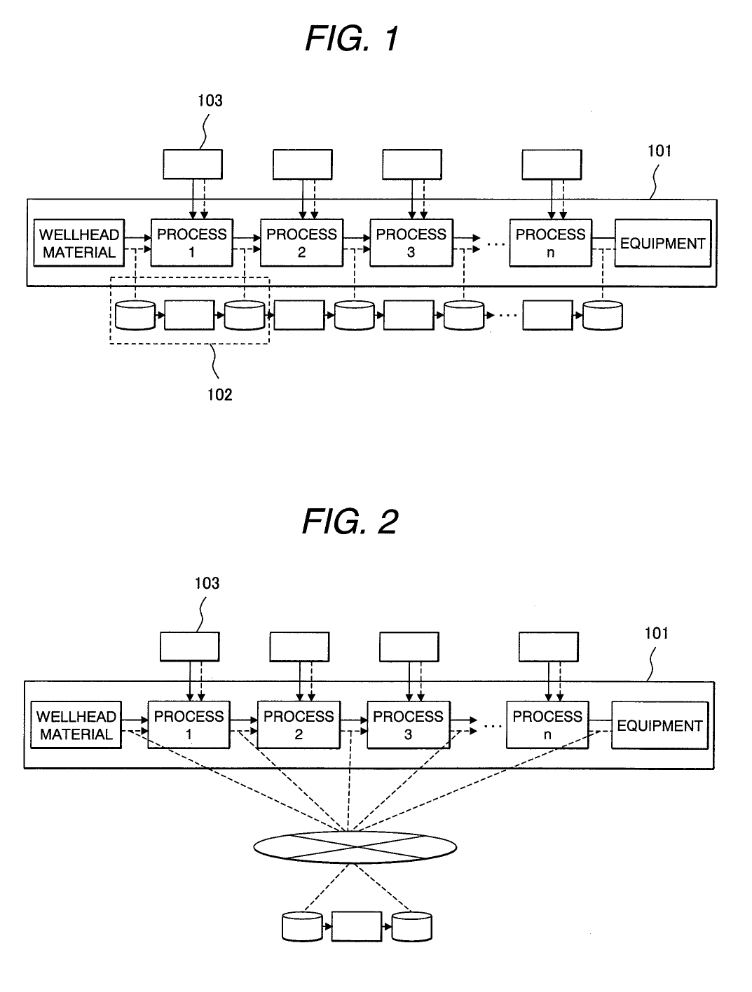

FIG. 1 is a schematic diagram in accordance with an embodiment of the invention, showing energy distribution processes for distributing a well head material, producing a fuel, and using it. Generally, a well head material is mined and transported to a place for storing, where energy of the material is converted and transformed into fuel. The converted and transformed fuel is transported to another place so as to be supplied to consumers, supplied to and used for the equipment. In FIG. 1, processes for mining, transportation, storage, conversion, transformation, and supply are represented as processes 1, 2, 3, 4, and so on. An environmentally affecting matter emission evaluation system 102 includes following means. One of the means inputs the amount of raw material supplied to the equipment included in each process, the amount of product resulting from the supplied raw material, the type of utility supplied for producing the product, and the amount of utility. Another means stores the input data. Another means stores an amount of an environmentally affecting matter emission basic unit per unit amount of various environmental emission matters with regard to raw materials, utilities, and products. Another means is an environmental emission calculation section which calculates an amount of an environmentally affecting matter emission from the amount of raw material, the utility, and the product, and the basic unit data. Another means stores a calculation result. Another means transmits or receives the data to or from another database.

A utility supply apparatus 103 includes a utility evaluation apparatus and outputs types and quantities of utilities to be input to the environmentally affecting matter emission evaluation system. The output data is transmitted from a communication apparatus provided for the utility supply apparatus 103 via communication networks, such as the Internet, intranet, and telephone lines to a communication apparatus of the environmentally affecting matter emission evaluation system and is finally stored in the database. The utility data may be stored in the environmentally affecting matter emission evaluation system without being supplied from the utility supply apparatus. The utility denotes, but is not limited to, energy, such as electric power and fossil fuel used for processing raw materials and commonly supplied, chemicals, and water.

Each process uses one or more databases to manage the means for storing the data. The database in each process manages input data to the process, calculation result data, and history data that include input data and calculation data acquired up to the preceding process. The history data contains at least the amount of raw material, emission basic unit of the raw material, utility types and quantities, and basic unit of the utility acquired up to the preceding process.

As shown in FIG. 2, the environmentally affecting matter emission evaluation system can also manage at least output data at a place other than the process equipment in the whole system or a system component. In this case, an external server is provided, connected to a data input apparatus of the each process equipment or the environmentally affecting matter emission evaluation system via a communication network, such as the Internet, intranet, or telephone lines. The data for each process maybe managed in a decentralized manner. Alternatively, the data for the entire distribution system may be managed in a centralized manner.

For example, the process 1 stores data such as the amount of raw material of well head material; the utility type and amount; the product amount; the emission basic units of the wellhead material, the utility, and the product; and calculation results. The process 2 stores at least the amount of raw material of the process 2, which is the product amount of the process 1; the utility type and amount; the product amount; emission basic units of wellhead material, utility, and product; calculation results; the amount of the raw material, an emission basic unit of the raw material, the utility type and amount, and an emission basic unit of utility in the process 1.

The process n stores at least the amount of raw material of the process n, which is the product amount of the process n−1; the utility type and amount; the product amount; emission basic units of wellhead material, utility, and product; calculation results; the amount of the raw material, an emission basic unit of the raw material, the utility type and amount, and an emission basic unit of utility in the processes 1 to n. The amount of raw material, product amount, and utility amount represent values measured by a flow meter or a platform scale and supplied directly or indirectly. As a means for inputting, transmitting, and receiving information about energy, a keyboard may be used and any other means may be also used, such as a pen input and input recognition system, a speech recognition device, and an RFID tag for storing data to be transmitted or received. It is preferable that a place for inputting the information should be provided with the process equipment, but the use of communication equipment, such as the Internet, intranet, or telephone lines makes the inputting possible at other places.

It is preferable to start exchanging data between processes when a raw material (product) is delivered.

The above-mentioned configuration enables the evaluation without consideration for a utility. In this case, however, it is impossible to consider a change in the emission basic unit of the utility depending on transportation facilities or electric power configurations.

The energy in the embodiment includes, for example, gasoline, light gas oil, kerosene, electricity, natural gas (city gas), propane gas, hydrogen, liquid hydrogen, high-pressure hydrogen, inorganic hydride, and organic hydride. The environmentally affecting matter includes CO₂, methane, dinitrogen monoxide, tropospheric ozone, chlorofluorocarbon, and moisture vapor.

The invention enables the environmentally affecting matter emission evaluation including environmentally affecting matter emission quantities generated while the energy itself is distributed and utilities, resulting in detailed evaluation of the amount of the environmentally affecting matter emission. Especially, the invention can provide an effective system that evaluates environmental characteristics of natural energy or energy generated from side products.

An operator for each process can regard the environmental characteristics as an indicator for purchasing a raw material.

### Second Embodiment

The following describes an embodiment of an energy production means in the energy environmentally affecting matter emission evaluation system described in the first embodiment.

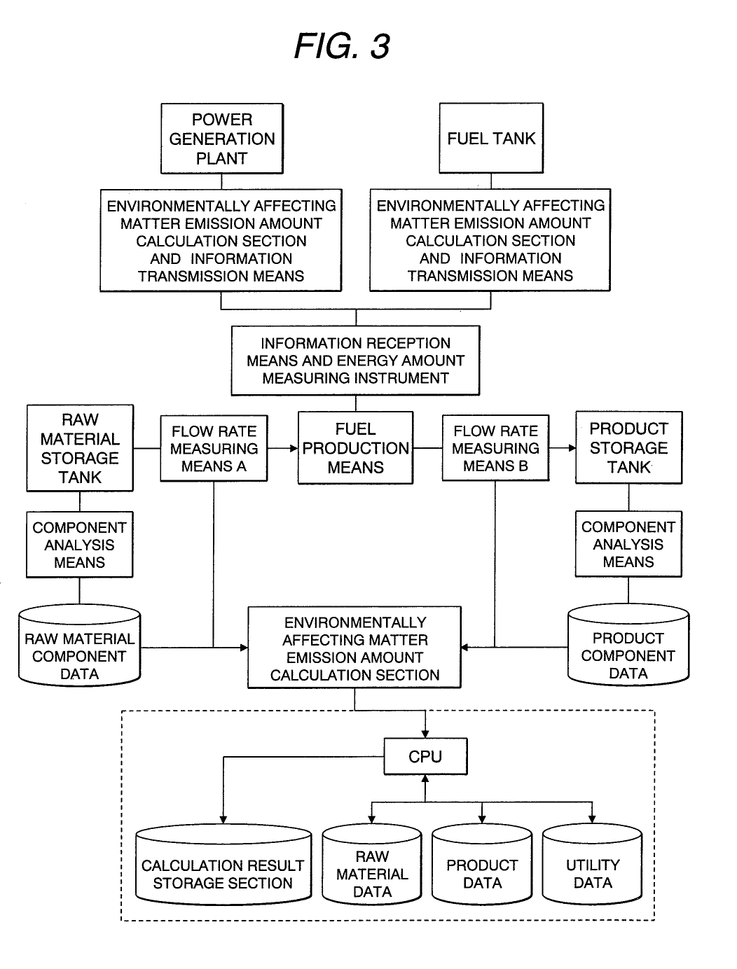

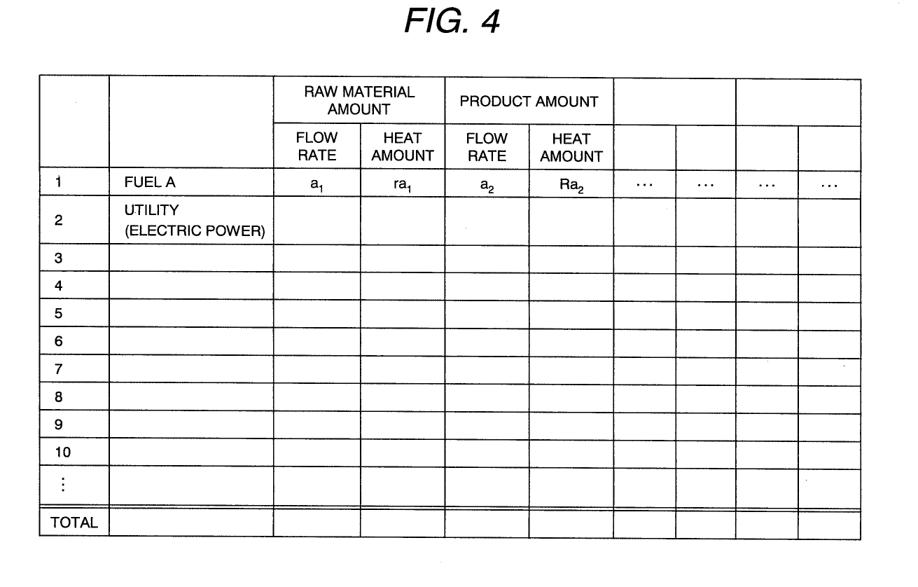

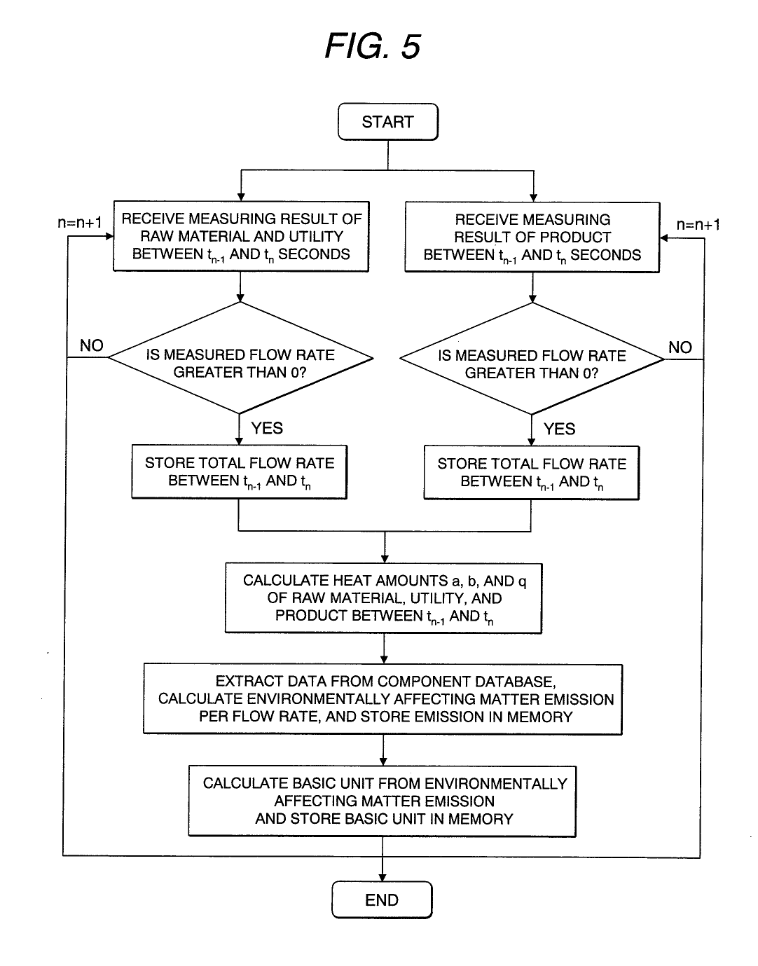

The energy production means in accordance with the embodiment is constructed as shown in FIG. 3, for example. The energy production means includes following means and tanks. A raw material storage tank stores a raw material. An energy production means receives the raw material from the raw material storage tank through a pipe arrangement, processes the raw material, and produces a product. A product storage tank stores the produced product through a pipe arrangement. A flow rate measuring means measures an amount of raw material supplied to the energy production means and a product amount supplied from the energy production means to the product storage means. The flow rate measuring means is capable of wired or wireless communication with the outside. The energy production means also includes a means that measures an amount of introduced utility energy, such as energy and electric power; a means for receiving or calculating an amount of the environmental emission per unit amount of a utility; a means for receiving the amount of raw material, product amount, and utility introduction information from the flow rate measuring means; and an environmentally affecting matter emission amount calculation section that calculates an amount of the environmentally affecting matter emission. The environmentally affecting matter emission amount calculation section for raw material components has a raw material component database that stores the environmentally affecting matter emission basic units and may include the environmental emission amount data per unit amount of a utility. The utility introduction information relates to an energy used for producing a product, including utility information, at least such as a type, a total efficiency up to the production, the environmentally affecting matter emission amount up to the production, a basic unit of the environmentally affecting matter emissions, and other utility attribute information such as production places and dates. The utility introduction information is issued from an energy environmentally affecting matter emission amount calculation section provided for each process that produces a utility. For example, a wellhead energy name, such as crude oil, maybe assigned to wellhead energy and a product generated by converting or transforming the wellhead energy. Let x₀ denote an amount of wellhead material, a₀ denote heat amount, b₀ denote an environmentally affecting matter amount per unit heat amount of the wellhead material, x₁, x₂, . . . , and xₙ denote the product amounts for each process in a supply chain, a₁, a₂, . . . , and aₙ denote product heat amounts, and b₁, b₂, . . . , and bₙ denote amounts of the environmentally affecting matter per unit heat amount for the raw material and the product from the raw material and product component database. These pieces of information are recorded, for example, in an environmentally affecting matter emission storage means, making it possible to measure the amount of environmentally affecting matters emitted from the entire supply chain. A table in FIG. 4 is an example form of data stored in the environmentally affecting matter emission storage means. The storage form is not limited to the table. The following describes, with reference to a flow chart in FIG. 5, a procedure for calculating amount of the environmentally affecting matter emission during an energy production process using the above-mentioned configuration. When the energy production means is supplied with a raw material, the flow rate measuring means A and B and a utility introduction amount measuring means C start each measurement. The flow rate measuring means measures flow rates r and R and a utility introduction amount q. A time-based value measured for each item is transmitted to the environmentally affecting matter emission amount calculation section. After receiving the information, the environmentally affecting matter emission amount calculation section calculates the heat amount of the supplied raw material, the product, and the utility based on data stored in a memory, using the following equation. In the following equation, the heat amount per raw material unit amount is denoted by a₁MJ/m³; time period between starting and stopping supplying the raw material and the utility is denoted by t seconds; fuel-collecting time is denoted by t′ seconds; the heat amount per product unit amount is denoted by a₂MJ/m³; and the utility amount per product unit amount is denoted by k₁MJ/m³.

raw material heat amount ∫(r×a₁)dt(MJ)

product heat amount ∫(R×a₂)dt(MJ)

utility heat amount ∫(q×k₁)dt (Equation 1)

The environmentally affecting matter emission amount calculation section then extracts b₁ and b₂, which are the amounts of the environmentally affecting matter per unit heat amount for the raw material and the product from the raw material and product component database. The environmentally affecting matter emission amount calculation section calculates the amount of the environmentally affecting matter at the energy production means M. The amount of the environmentally affecting matter S′ is calculated according to the following equation, where l₁ denotes the environmentally affecting matter amount per unit amount heat for the utility.

S′=∫ⁱr×a₁×b₁dt−∫ⁱR×a₂×b₂dt+∫ⁱq×k₁×l₁dt (Equation 2)

An environmentally affecting matter emission amount basic unit Sₙₒᵣₘ′ is calculated as follows.

$${S}_{norm}^{′} = \frac{\begin{matrix}{\int }^{i} r \times {a}_{1} \times {b}_{1} d t - \\ {\int }^{i} R \times {a}_{2} \times {b}_{2} d t + {\int }^{i} q \times {k}_{1} \times {l}_{1} d t\end{matrix}}{R \times {a}_{2}} \qquad ( Equation 3 )$$

If all the amount of the wellhead material x₀ is transferred to the fuel production means M, the environmentally affecting matter amount Sₐₗₗ for the entire supply chain is expressed as follows.

Sₐₗₗ=x₀×a₀×b₀−∫ⁱR×a₂×b₂dt+∫ⁱq×k₁×l₁dt ,

where a₀ is the heat amount (MJ/m³)per unit amount of the wellhead material and b0 is the environmentally affecting matter amount per unit heat amount of the wellhead material. The environmentally affecting matter emission amount basic unit S_{all/norm} is expressed as follows.

$${S}_{all / norm} = \frac{\begin{matrix}{x}_{0} \times {a}_{0} \times {b}_{0} - \\ {\int }^{i} R \times {a}_{2} \times {b}_{2} d t + {\int }^{i} q \times {k}_{1} \times {l}_{1} d t\end{matrix}}{R \times {a}_{2}} \qquad ( Equation 4 )$$

The results are stored in a table form, for example, in a calculation result storage section.

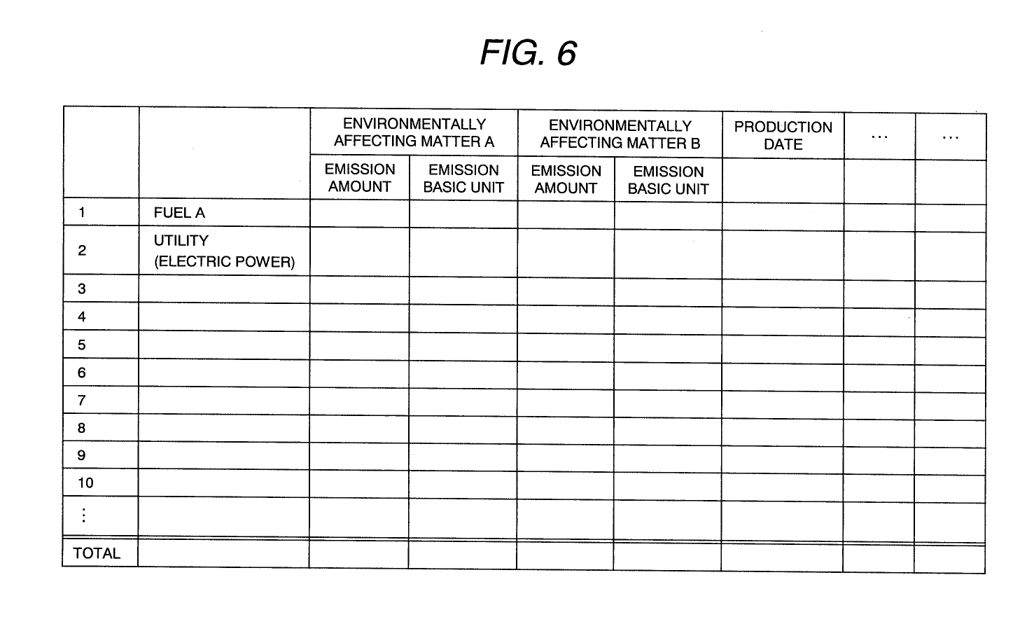

The environmentally affecting matter emission amount calculation section may include a clock function to specify a production date and time. The calculation results are stored in a table form as shown in FIG. 6, which the storage format is not limited to, in the calculation result storage section. The table form may include energy attributes, such as an environmentally affecting matter name and a production date.

Generally, the raw material and product component database include approximate amount of the environmentally affecting matter emission of raw materials and products. It is possible to calculate the amount of the environmentally affecting matter emission, always reflecting the accurate amount of the environmentally affecting matter when the raw material storage tank and the product storage tank is provided with a component analysis apparatus for chromatography and so on, which always updates the amount of environmentally affecting matters contained in the raw material and the product.

The environmentally affecting matter amount l₁ per unit amount heat for the utility can be stored as unchanged data in the memory. Alternatively, l₁ can be calculated considering day-night variation of a power generation ratio of the system power. The calculation is possible by providing at least one environmentally affecting matter emission amount calculation section with the each power generation plant in FIG. 3. The each power generation plant includes a database server for storing an electric generating capacity Kₙ and an environmentally affecting matter amount Lₙ per unit heat amount. The power generation plant also includes a transmitter for transmitting the data to customers and an apparatus for the customer who receives the data to calculate an environmentally affecting matter amount L per heat amount of supplied power as follows.

$$\begin{matrix}L = \frac{{K}_{0} {L}_{0} + {K}_{1} {L}_{1} + {K}_{2} {L}_{2} + … + {K}_{n} {L}_{n}}{{K}_{0} + {K}_{1} + {K}_{2} + … + {K}_{n}} \\ = \frac{\sum {K}_{m} {L}_{m}}{\sum {K}_{m}}\end{matrix} \qquad ( Equation 5 )$$

The environmental emission amount l₁=L per unit heat amount of the utility is determined with the equation 5 in this way. The calculation result storage section stores this result in a table form, for example. When the energy is passed to the next process, data in the calculation result storage section is transmitted to data for the next process along with the energy and then stored in the database. This makes it possible to evaluate the amount of the environmentally affecting matter emission including the utility in the energy supply chain, resulting in detailed evaluation of the amount of the environmentally affecting matter emission.

The invention enables the environmentally affecting matter emission evaluation including environmentally affecting matter emission quantities generated while the energy itself is distributed and utilities, resulting in detailed evaluation of the amount of the environmentally affecting matter emission. Especially, the invention can provide an effective system that evaluates environmental characteristics of natural energy or energy generated from side products.

An operator for each process can regard the environmental characteristics as an indicator for purchasing a raw material.

### Third Embodiment

The following describes an embodiment of an energy transportation means in the energy environmentally affecting matter emission evaluation system described in the first embodiment.

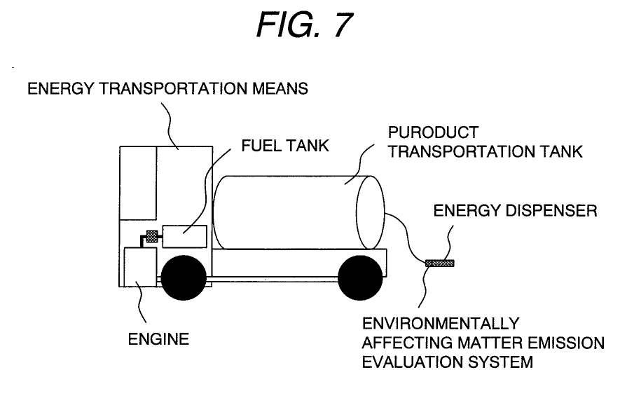

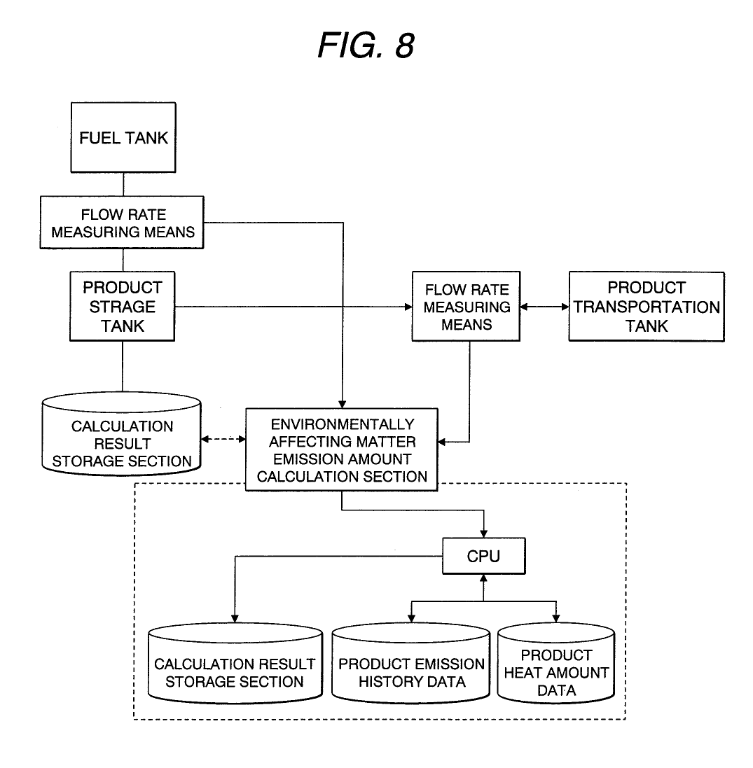

As shown in FIG. 7, the environmentally affecting matter emission evaluation system attached to the energy transportation means is provided for a product transportation tank or a dispenser of the energy transportation means. FIG. 8 shows a configuration of the system, which includes a flow rate measuring means for measuring a product amount when the energy is transferred as a product from a product storage tank of an energy production means to a product transportation tank and for transmitting measurement results via wired or wireless communication to the outside; a means for receiving a product amount from the flow rate measuring means; a means for measuring a utility amount used for the transportation; an environmentally affecting matter emission amount calculation section for calculating an amount of the environmentally affecting matter emission; and a memory for receiving calculation result data from the environmentally affecting matter emission amount calculation section of the energy production means.

Concerning the received raw material, for example, let r′ denote the amount of raw material, a₀ denote the heat amount per unit energy, b₀ denote the basic unit of the environmentally affecting matter emission, R denote the amount of raw material to be delivered to a transportation destination, r″ denote the amount of raw material remaining in the transportation equipment after the delivery to the transportation destination, q₁ denote the energy amount required for the transportation equipment to move from an energy supply place to the transportation destination, k₂ denote the heat amount per unit energy, and l₂ denote the basic unit of the environmentally affecting matter emission. The raw material component database in the environmentally affecting matter emission amount calculation section for raw material components stores these pieces of data. The environmentally affecting matter emission amount calculation section includes the flow rate measuring means; the means for measuring the utility energy amount; the means for receiving or calculating an environmental emission amount per unit amount of a utility; and the means for receiving the amount of raw material, the product amount, and the utility introduction amount from the flow rate measuring means. Based on these data, the environmentally affecting matter emission amount calculation section calculates emission basic unit Sₙₒᵣₘ of the energy emitted from the transportation equipment as follows.

$${S}_{norm} = \frac{( {r}^{′} - R - {r}^{″} ) \times {a}_{1} \times {b}_{1} + {q}_{1} \times {k}_{2} \times {l}_{2}}{R \times {a}_{1}} \qquad ( Equation 6 )$$

An accumulated CO₂ emission basic unit is calculated as follows.

$${S}_{all / norm} = \frac{\begin{matrix}{x}_{0} \times {a}_{0} \times {b}_{0} - R \times {a}_{2} \times {b}_{2} + \\ {q}_{1} \times {k}_{2} \times {l}_{2} + \frac{R}{{r}^{′}} q \times {k}_{1} \times {l}_{1}\end{matrix}}{R \times {a}_{2}} \qquad ( Equation 7 )$$

The calculation result storage section stores the results in a table form, for example. When the energy is passed to the transportation destination, data in the calculation result storage section is transmitted to the transportation destination along with the energy. This makes it possible to evaluate the amount of the environmentally affecting matter emission including the utility in the energy supply chain, resulting in detailed evaluation of the amount of the environmentally affecting matter emission.

The amount of the utility used for fuel transportation also can be previously calculated in the evaluation by providing a means for acquiring the utility type, the efficiency in each process and the total efficiency up to the utility production, data up to the production such as the environmental emission amount and the environmental emission basic unit, and positioning data that is obtained from places for supply and consuming the utility or from a GPS (Global Positioning System). The amount of the utility can be calculated in more detail if information is provided about a method and energy for transporting the utility.

### Fourth Embodiment

The following describes an embodiment of an energy storage means in the energy environmentally affecting matter emission evaluation system described in the first embodiment.

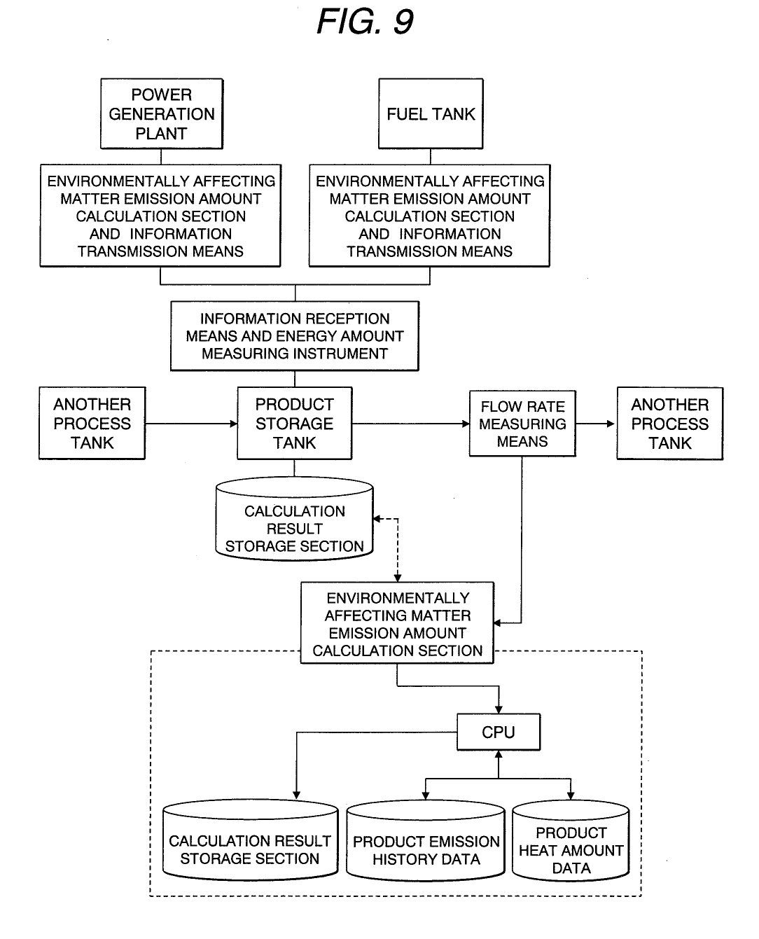

FIG. 9 shows a configuration of the environmentally affecting matter emission evaluation system attached to the energy storage means. The system includes a flow rate measuring means for measuring an amount of raw material when transporting energy from a pipe arrangement for receiving the raw material to a product tank and for transmitting measurement results via wired or wireless communication to the outside; a means for receiving a product amount from the flow rate measuring means; a means for measuring a utility amount used for the transportation; another flow rate measuring means for measuring the product amount when the product stored in the product tank is delivered to another process and for transmitting measurement results via wired or wireless communication to the outside; a means for measuring a utility amount used for the storage; an environmentally affecting matter emission amount calculation section for calculating an amount of the environmentally affecting matter emission; and a memory for receiving calculation result data from the environmentally affecting matter emission amount calculation section of the energy production means.

Concerning the received raw material, for example, let r′ denote the amount of raw material, a₀ denote the heat amount per unit energy, b₀ denote the basic unit of the environmentally affecting matter emission, R denote the amount of raw material to be delivered to another process, r″ denote the amount of raw material remaining in the storage equipment after the delivery to the other process, q₁ denote the energy amount required for maintaining the storage, k₂ denote the heat amount per unit energy, and l₂ denote the basic unit of the environmentally affecting matter emission. The raw material component database in the environmentally affecting matter emission amount calculation section for raw material components stores these pieces of data. The environmentally affecting matter emission amount calculation section includes the flow rate measuring means; the means for measuring the utility energy amount; the means for receiving or calculating an environmental emission amount per unit amount of a utility; and the means for receiving the amount of raw material, the product amount, and the utility introduction amount from the flow rate measuring means. Based on these data, the environmentally affecting matter emission amount calculation section calculates emission basic unit Sₙₒᵣₘ of the energy emitted from the storage equipment as follows.

$${S}_{norm} = \frac{( {r}^{′} - R - {r}^{″} ) \times {a}_{1} \times {b}_{1} + {q}_{1} \times {k}_{2} \times {l}_{2}}{R \times {a}_{1}} \qquad ( Equation 8 )$$

An accumulated CO₂ emission basic unit is calculated as follows.

$${S}_{all / norm} = \frac{\begin{matrix}{x}_{0} \times {a}_{0} \times {b}_{0} - R \times {a}_{2} \times {b}_{2} + \\ {q}_{1} \times {k}_{2} \times {l}_{2} + \frac{R}{{r}^{′}} q \times {k}_{1} \times {l}_{1}\end{matrix}}{R \times {a}_{2}} \qquad ( Equation 9 )$$

The calculation result storage section stores the results in a table form, for example. When the energy is passed to the other process, data in the calculation result storage section is transmitted to the other process along with the energy. This makes it possible to evaluate the amount of the environmentally affecting matter emission including the utility in the energy supply chain, resulting in detailed evaluation of the amount of the environmentally affecting matter emission.

The invention enables the environmentally affecting matter emission evaluation including environmentally affecting matter emission quantities generated while the energy itself is distributed and utilities, resulting in detailed evaluation of the amount of the environmentally affecting matter emission. Especially, the invention can provide an effective system that evaluates environmental characteristics of natural energy or energy generated from side products.

An operator for each process can regard the environmental characteristics as an indicator for purchasing a raw material.

### Fifth Embodiment

The following describes an embodiment of evaluating the emission amount of environmentally affecting matter when mixed energies are sold through the use of the basic configuration of the environmentally affecting matter emission evaluation system according to the first embodiment. The embodiment is particularly effective for a secondary energy, such as hydrogen, obtained by processing a primary energy. The embodiment is also effective for supplying a mixture of hydrogen and methane to consumers. Generally, hydrogen is known as clean energy that emits no environmentally affecting matter. However, hydrogen is a secondary energy nonexistent in the natural world and an environmentally affecting matter such as CO₂ is emitted during the production process.

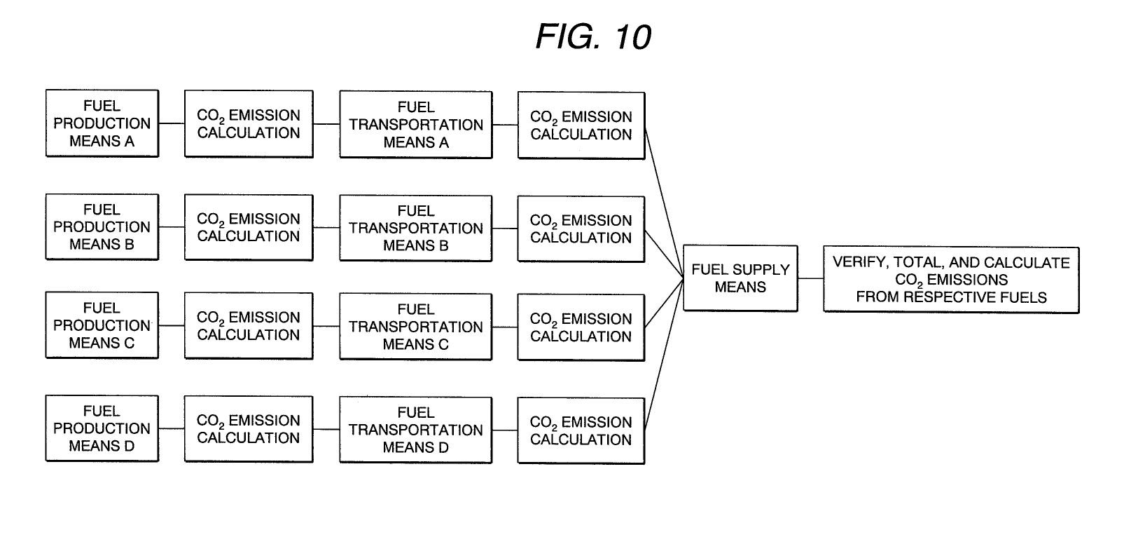

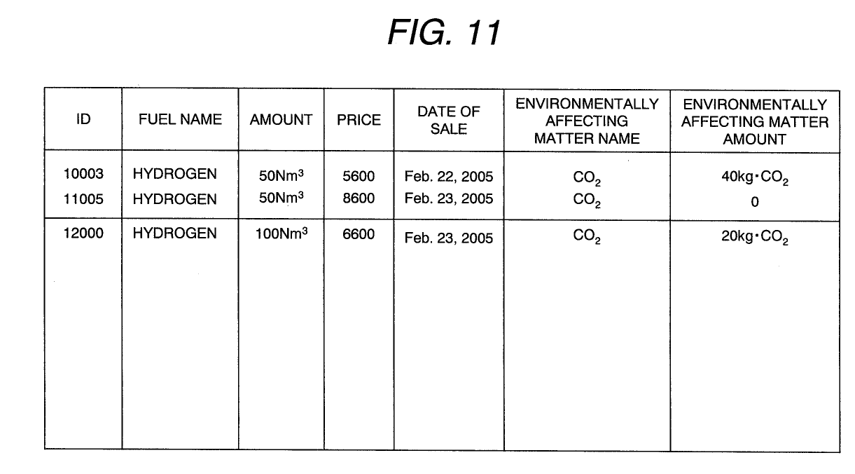

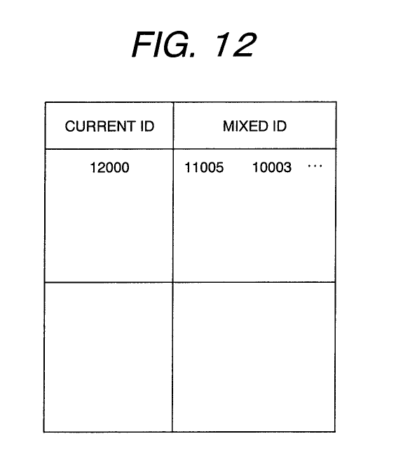

As shown in FIG. 10, a plurality of production means produce energies in accordance with the configurations of the first, second, and third embodiments. The energies are of the same property but differ from each other in environmentally affecting matters and emission amounts. The energies are transported to one supplier through a plurality of transportation means, stored in one tank, and supplied to consumers. In this case, the system manages the amount of the environmentally affecting matter as follows. While the energy name is used to manage the energy in the first embodiment, the each energy is identified by an ID number and managed as shown in FIGS. 11 and 12 in this embodiment. This makes it possible to manage the same kind of energy independently. The IDs are issued by data exchange while the energy is moved from the production means to the transportation means.

The process follows the flowchart in FIG. 5 even when energies are moved from a plurality of transportation means to the supply means and mixed.

The energy amount of the each filled energy is, respectively, measured by an energy measuring means and evaluated by an energy reserve evaluation means. At the time when the filling of the energy is completed, data about the energy amount evaluated by the energy reserve evaluation means is transmitted to the environmentally affecting matter emission storage means concerning the production energies. As shown in FIG. 10, an ID of the filled energy can be associated with an ID of the current energy so as to manage data for mixing purposes. The system retrieves two pieces of environmentally affecting matter emission data from an environmentally affecting matter emission storage means at an energy supply station. One of the data relates to an energy newly added from the environmentally affecting matter emission storage means for production means. The other relates to an energy stored in the energy supply station. The system uses an environmentally affecting matter storage evaluation system at the energy supply station to re-evaluate an amount of the environmentally affecting matter storage at the energy supply station after the new energy is added. The environmentally affecting matter storage means at the energy supply station stores the result. An environmentally affecting matter storage means 110 at the energy supply station is capable of history management by adding environmentally affecting matter emission data of an intended energy, an energy entry ID, and an energy addition date. It is possible to analyze cost change evaluation or cost minimization according to mixture ratios by evaluating a cost or an environmental emission amount for the each energy.

The invention can clearly notify consumers of environmental characteristics of energy even if the energy is sold in a mixture of an excessively inexpensive energy with degraded environmental characteristics and an excessively expensive energy with excellent environmental characteristics.

### Sixth Embodiment

The following describes an embodiment of calculating a carbon tax on energy to be sold in the environmentally affecting matter emission evaluation system according to the first to fifth embodiments. The embodiment provides, but is not limited to, an example of evaluating a carbon tax using a technique of estimating a carbon tax on a product from CO₂ emissions accumulated at each process in a supply chain. Preferably, energy in this embodiment is managed by an ID number as described in the fourth embodiment. According to energy IDs, an environmentally affecting matter emission storage means stores at least information about a place of emitting an environmentally affecting matter, the amount of the environmentally affecting matter emission at each place, and a carbon tax rate. Information about the carbon tax may be stored in another database.

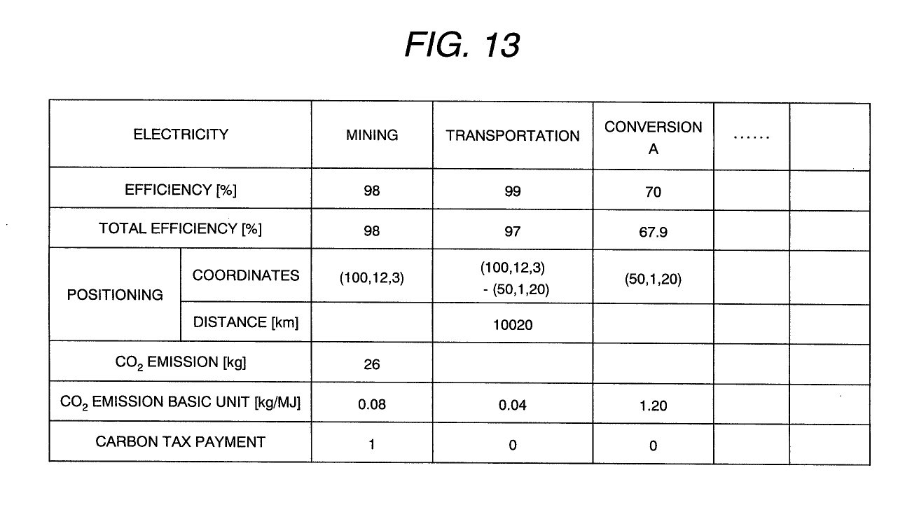

Suppose that factories A and B process energies A and B, respectively, emitting amounts C and C′ of environmentally affecting matter, respectively, and are subject to carbon tax rate D. If the factory A sells a product at a price x exclusive of carbon tax, the product is sold from the factory A to B at a price x+C×D. Carbon tax rate D applied to the product can be updated when the data transmission and reception function of the environmentally affecting matter emission evaluation system is connected to communication means, such as the Internet. The following describes a case of considering the utility according to the second embodiment. The utility introduction information is stored in a table form according to types as shown in FIG. 13. The utility introduction information includes a utility type, efficiency in each process and total efficiency up to the utility production, a CO₂ emission amount and a CO₂ emission basic unit up to the production, and a production place. The production place is defined as data specified by a utility supply place and a consumption place, such as, but is not limited to, positioning data from the GPS (Global Positioning System) or a geographical name. Data supplied by the GPS, for example, indicating a relative distance between the supply place and the consumption place, can be linked with map data, leading to calculation of an energy transportation distance and another utility amount consumed during utility transportation. More detailed calculation is possible when information about a method and energy of a utility transportation are provided. If information indicating whether the carbon tax is paid or not is stored, it is possible to clearly indicate a point of paying the carbon tax before the utility is supplied. In succession to the above-mentioned example, suppose that factory A produces energy A; factory B produces energy B from energy A; factory B′ produces energy B′ from energy B; the each producing process emits amounts C, C″, and C″ of the environmentally affecting matter, respectively; and the factories are subject to carbon tax rate D. A product is sold from the factory A to B at a price x+C×D if the factory A sells the product at a price x exclusive of carbon tax. The product shipped from the factory B to B′ is priced at x′+(C+C′)×D when the factory B sells the product at price x′ exclusive of carbon tax. Similarly, the product shipped from the factory B″ is priced x″+(C+C′+C″)×D when the factory B′ sells the product at price x″ exclusive of carbon tax. Carbon tax payment states of the factories are obtained from the utility introduction information in FIG. 13. In the carbon tax payment state for each process, value 0 indicates that the tax is unpaid and value 1 indicates that the tax is paid. If the factory A has paid the carbon tax, C is 0 and the product from factory B′ is priced at x″+(C′+C″)×D.

The description of paid or unpaid of carbon tax can be provided with information about raw materials and products besides the utility.

The results can be described in the utility introduction information, transmitted to a database that stores data and is used for the other processes. The information can be displayed and printed by using apparatus for reading and displaying the results, such as a personal computer or a dedicated processing device, a monitor, and a printer.

The invention makes it possible to estimate the carbon tax on energy and utility, and also possible to specify the carbon tax to energy purchasers.

What is claimed is:

1. A fuel environmental evaluation system for evaluating a fuel environment characteristic in an energy distribution process comprising:
a means for inputting an amount of raw material supplied to equipment for each process of energy distribution, an amount of product produced from each equipment for each process, and a type and an amount of utility supplied to the equipment for each process when producing the product;
a storage means for storing input data;
a storage means for storing a basic unit for an amount of environmentally affecting matter emission per unit amount of an environmental emission matter in the raw material, utility and product;
an environmental emission calculation section for calculating an amount of environmentally affecting matter emission from data of amounts of the raw material, utility and product, and the basic unit for the amount of environmentally affecting matter emission; and
a means for storing a calculation result from the environmental emission calculation section.

2. A fuel environmental evaluation system for evaluating a fuel environment characteristic in an energy distribution process comprising:
a database for storing an amount of raw material supplied to equipment for each process of energy distribution, an amount of product produced from the equipment for each process, and a type and an amount of utility supplied to the equipment for each process when producing the product, and an environmental emission basic unit for the product;
an environmentally affecting matter emission evaluation means for evaluating an amount of an environmentally affecting matter emitted when producing of the product, based on data stored in the database; and
a product-related environmentally affecting matter emission amount storage means for storing a result evaluated by the environmentally affecting matter emission evaluation means,
wherein the system evaluates an amount of accumulated environmentally affecting matter emission in all processes of energy distribution distributing energy processed from a wellhead material.

3. The fuel environmental evaluation system according to claim 2, further comprising:
a utility usage information storage means for storing data recording an energy used as a utility when using of the utility.

4. The fuel environmental evaluation system according to claim 2,
wherein the environmentally affecting matter emission amount storage means is comprised of:
a means for measuring an amount of product received from a manufacturing site in a transportation means for product or raw material and an amount of raw material transferred from the transportation means to the manufacturing site;
an environmentally affecting matter emission amount evaluation means for evaluating an amount of environmentally affecting matter emission concerning an amount of the product or raw material remaining in a storage tank of the transportation means; and
an environmentally affecting matter emission amount storage means concerning the product or raw material in the transportation means.

5. The fuel environmental evaluation system according to claim 4,
wherein the environmentally affecting matter emission amount evaluation means quantifies the amount of environmentally affecting matter emission by using input data including at least an amount of raw material, a heat value of the raw material heat, a basic unit of an environmentally affecting matter emission amount derived from the raw material, a heat value of the product, the amount of the product, and a basic unit of an environmentally affecting matter emission amount derived from the product.

6. The fuel environmental evaluation system according to claim 2, further comprising:
a plurality of the environmentally affecting matter emission amount storage means corresponding to respective processes,
wherein exchanging a evaluation results stored in the plurality of the environmentally affecting matter emission amount storage means with one another between the storage means is made possible by using a wired or wireless communication apparatus.

7. The fuel environmental evaluation system according to claim 2,further comprising:
an environmentally affecting matter tax evaluation means for storing carbon tax data required per unit amount of a fuel or an energy supplied to the equipment and a carbon tax calculation function for calculating a carbon tax based on the data.

8. The fuel environmental evaluation system according to claim 2, further comprising:
a transmission means that appends fuel identification information to a produced fuel transported by a transportation means, and transmits the fuel identification information and the following data to a database at a fuel supply destination;
the data concerning a transportation amount of the fuel at a production process and the environmentally affecting matter emission amount corresponding to the transportation amount; and
a calculating means that verifies information concerning the produced fuel transported by the transportation means and fuel information of the fuel supply destination by using the fuel identification, and calculates a difference between a fuel transportation amount and a fuel incoming amount in the transportation and calculates the environmentally affecting matter emission amount corresponding to the difference.

9. The fuel environmental evaluation system according to claim 2, comprising:
a server provided elsewhere than each process equipment,
wherein the server is connected with a data input apparatus or an environmentally affecting matter emission amount evaluation means of each process equipment through a communication network such as Internet, intranet, and telephone line so as to centrally manage data for an overall energy distribution.
